(19) United States
(12) Patent Application Publication
(10) Pub. No.: US 2009/0260400 A1
(43) Pub. Date: Oct. 22, 2009

(54) Method for Producing a Tubular Semifinished Product From Fluorine-Doped Quartz Glass

(75) Inventors: Gerhard Schoetz, Aschaffenburg (DE); Karsten Braeuer, Bruchkoebel (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: HERAEUS QUARZGLAS GMBH & CO., KG, HANAU (DE)

(21) Appl. No.: 12/227,195

(22) PCT Filed: Jun. 26, 2007
(86) PCT No.: PCT/EP2007/056354

§ 371 Date: Nov. 10, 2008

(30) Foreign Application Priority Data
Jul. 7, 2006 (DE) 10 2006 031 898.6

(51) Int. Cl. C03B 37/018

(52) U.S. Cl. 65/391

(57) ABSTRACT

To improve a generally known method for producing a tubular semifinished product from fluorine-doped quartz glass such that it is possible to produce a tubular semifinished product of fluorine-doped quartz glass with an inner bore of high quality while the efforts for making or treating the same are as small as possible, the present invention suggests a method comprising the following steps: (a) providing a substrate tube consisting of fluorine-doped quartz glass; (b) forming, in a deposition process, SiO₂ particles by means of plasma burners and in the presence of fluorine, and depositing said particles in layers on the cylindrical outer surface of the substrate tube rotating about its longitudinal axis with formation of a mother tube consisting of fluorine-doped quartz glass; and (c) elongating the mother tube in an elongation process to obtain the tubular semifinished product.

The invention refers to a method for producing a tubular semifinished product from fluorine-doped quartz glass.

Fluorine reduces the refractive index of quartz glass. Tubular semifinished products consisting of fluorine-doped quartz glass are used for producing preforms for optical fibers.

DE 25 364 57 A1 discloses a method for producing preforms, wherein fluorine-doped quartz glass is deposited on a core glass cylinder of undoped quartz glass as the cladding glass layer. To this end an induction-coupled plasma burner is used to which starter substances are supplied from which fluorine-containing SiO₂ particles are formed in the plasma flame, the particles being deposited in layers on the core glass cylinder rotating about its longitudinal axis and said particles being directly sintered on the core glass layer with formation of the fluorine-containing SiO₂ particles. This method for producing a preform for optical fibers is also called “POD method” (plasma outside deposition).

However, methods for producing preforms are also known wherein tubes of fluorine-doped quartz glass are used. The fluorine-doped quartz glass tubes are used either as overcladding cylinders in the manufacture of preforms by means of the so-called rod-in-tube method, or as so-called “substrate tubes” in an MCVD method (modified chemical vapor deposition), wherein layers of doped or undoped quartz glass are produced on the inner wall of the substrate tube by depositing SiO₂.

To produce tubular semifinished products of fluorine-doped quartz glass according to the above mentioned POD method, a silicon-containing starter substance is supplied to a plasma burner, said substance is oxidized in a plasma flame assigned to the plasma burner to obtain SiO₂ particles, and the SiO₂ particles are deposited in the presence of fluorine on the cylindrical outer surface of an elongated support rotating about its longitudinal axis.

Such a method is described in U.S. Pat. No. 6,253,580 B1. To produce a tubular semifinished product of fluorine-doped quartz glass according to the POD method, a dry plasma flame is produced in which SiCl₄ is oxidized into SiCl₂ particles and said particles are deposited on a support body and vitrified immediately. Fluorine-doped quartz glass is obtained by introducing fluorine into the plasma flame. The support body is configured as a tube consisting of doped or undoped quartz glass or as a solid rod of graphite which may additionally be coated with a thin enveloping tube of quartz glass.

The support material is removed by drilling or etching in a final step so as to obtain a tube of fluorine-doped quartz glass that is used as an enveloping material for a core glass for producing a preform for optical fibers.

A similar method for producing a tubular semifinished product of fluorine-doped quartz glass is also known from DE 103 16 487 A1. It is suggested in said publication that a substrate tube of quartz glass with a wall thickness ranging between 2 mm and 10 mm should be used as a support for the POD method, with the tube being removed mechanically (by grinding, polishing, drilling) or chemically (by etching with SF₆) after completion of the deposition process.

A decisive criterion for the quality of the tubular semifinished product obtained in this way is the quality of the surface of the inner bore, for this surface normally gets into direct contact with near-core layers of the preform and the optical fiber obtained therefrom. Therefore, the removal of the support body and a possible reworking of the inner bore of the tubular semifinished product requires particularly great care and is very time consuming and expensive.

It is the object of the present invention to provide a method that makes it possible to produce a tubular semifinished product of fluorine-doped quartz glass with an inner bore of high quality while the efforts for making or treating the same are as small as possible.

Starting from the above-mentioned method, this object is achieved by way of a method comprising the following method steps:
a) providing a substrate tube consisting of fluorine-doped quartz glass;
b) forming, in a deposition process, SiO₂ particles by means of plasma burners. and in the presence of fluorine, and depositing said particles in layers on the cylindrical outer surface of the substrate tube rotating about its longitudinal axis with formation of a mother tube consisting of fluorine-doped quartz glass; and
c) elongating the mother tube in an elongation process to obtain the tubular semifinished product,
whereby providing the substrate tube according to method step (a) is carried out in an iterative method and comprises the following measures:
   (A) in a deposition process SiO₂ particles are formed by means of plasma burners and in the presence of fluorine and are deposited with formation of a starter tube on a cylindrical outer surface of a support body rotating about its longitudinal axis, and
   (B) in an elongation process the starter tube is elongated into a tube consisting of fluorine-doped quartz glass, which is used as a support body according to measure (A) or as a substrate tube according to method step (a).

In the method of the invention a substrate tube of fluorine-doped quartz glass is first of all provided. Manufacture and possibly necessary reworking of the inner bore for achieving a high surface quality of said tube require not more than those efforts that are otherwise needed for providing a substrate tube.

The substrate tube is subjected to further processing comprising a POD deposition process and an elongation process.

In the POD deposition process, a layer of fluorine-doped quartz glass is deposited on the substrate tube. The result is a thick-walled “mother tube” of fluorine-doped quartz glass having approximately the length of the substrate tube. In this method step, the quality of the surface of the inner bore does not or not significantly change in the presence of an appropriate process control.

In a subsequent elongation process, the semifinished product is produced by elongation from the thick-walled mother tube. In this method step the quality of the surface of the inner bore does also not change. On the contrary, a preferred variant of the method in which the inner bore of the resulting tubular semifinished product is formed without any tools yields an inner surface of a particularly high surface quality smoothed by hot deformation.

The total length of the resulting tubular semifinished products of fluorine-doped quartz glass is many times greater than that of the individual substrate tube without any additional efforts being required for producing or treating the inner bore. Apart from the initial substrate tube, efforts for producing or treating the inner bore are ideally not required in the semifinished product produced according to this method. Thus, when this semifinished product is used, for instance as an overcladding cylinder in the rod-in-tube method, as a “substrate tube” in an MCVD method, or as a starter material for making so-called PCF fibers (photonic crystal fibers), optical components such as preforms and optical fibers are produced at especially low costs.

In this instance the provision of the substrate tube according to method step (a) is carried out in an iterative method comprising the following measures:
(A) in a deposition process SiO₂ particles are formed by means of plasma burners and in the presence of fluorine and are deposited in layers with formation of a starter tube on a cylindrical outer surface of a support body rotating about its longitudinal axis, and
(B) in an elongation process the starter tube is elongated into a tube consisting of fluorine-doped quartz glass, which is used as a support body according to measure (A) or as a substrate tube according to method step (a).

The starter tube for producing a semifinished product according to customer specification is here called _{“}substrate tube” and a starter tube for producing a substrate tube is here called _{“}support body”. Hence, the provision of a substrate tube is carried out in an iterative procedure. To this end a tube of fluorine-doped quartz glass is first produced by means of a standard POD method. The resulting tube is here called _{“}starter tube”. The starter tube, however, is not directly used as a semifinished product for producing a preform, but is subjected to further processing comprising an elongation process, and in the course of this either a substrate tube for producing the semifinished product or a support body for producing substrate tubes is obtained.

Hence, the result of the elongation process according to measure (B) is a thin-walled tube having a length greater than that of the starter tube. In the elongation process the quality of the inner bore of the original starter tube does not deteriorate. On the contrary, in a preferred variant of the method in which the inner bore of the resulting tube is formed without any tools, one obtains an inner surface of a particularly high surface quality smoothed by hot deformation.

The resulting tube has a length several times the length of the starter tube and can be cut to length into several segments for carrying out the next method step. The next method step according to the invention includes either a further POD deposition process according to method step (b) in which on the substrate tube (or on a segment thereof) a layer of fluorine-doped quartz glass is produced with formation of a _{“}mother tube” of fluorine-doped quartz glass, or a further POD deposition process according to measure (A) wherein a layer of fluorine-doped quartz glass is produced on the support body (or a segment thereof) with formation of a _{“}starter tube” of fluorine-doped quartz glass.

Hence, when the tube is used as the substrate tube, either a very long thick-walled mother tube with the length of the substrate tube can be obtained from the substrate tube, or several shorter thick-walled mother tubes are obtained, depending on the number of substrate tube segments. The total length of fluorine-doped tubular quartz glass produced in this way is at any rate many times greater than the length of the original starter tube without the need for greater efforts for producing and treating the inner bore.

The total length of fluorine-doped tubular semifinished product is even increased by every further elongation process without any additional efforts being needed for treating or producing the inner bore.

Advantageously, during the first run of the iterative method and prior to the elongation process according to measure (B) the support body is removed with formation of the starter tube consisting of fluorine-doped quartz glass.

During the first run of the iterative method the support body is for instance a rod-like or tubular component consisting of quartz glass, ceramics, or graphite. Due to the removal of the support body prior to the elongation process the length of the inner bore to be treated is limited to the length of the starter tube.

In a particularly preferred variant of the method a hollow cylindrical support body which comprises an inner bore and consists of quartz glass is used in the deposition process according to measure (A), the support body being removed by introducing an etching gas into the inner bore thereof.

In comparison with mechanical drilling or grinding the removal of the support body by way of etching offers the advantage that a low-stress and predominantly defect-free inner bore can be produced without any considerable efforts. The etching gas used is preferably SF₆, which brings about a rapid etching off of the quartz glass with formation of volatile compounds of silicon and fluorine.

Advantageously, in the first elongation process according to measure (B), a tube is produced with an outer diameter corresponding to the outer diameter of the support body.

This makes it easier to carry out the POD deposition method using the tube as the support body because the SiO₂ deposition on a support body or a substrate tube is each time carried out with an initially identical or similar outer diameter. A deviation of +/−20% (based on the outer diameter of the support body) is not detrimental in this respect. For the same reason in the making of a substrate tube according to measure (B) the setting of an outer diameter corresponding to that of the original support body is also of advantage.

Advantageously, in the elongation process according to method step (c) or according to measure (B) the inner diameter of the tube to be elongated is changed by not more than +/−20% (based on the inner diameter prior to the elongation process).

Moreover, it has turned out to be useful when in the elongation process according to method step (c) or according to measure (B) an internal pressure that is raised in comparison with the external pressure applied to the outside is produced and maintained in the inner bore of the tube to be elongated.

The raised internal pressure in the elongation process permits a particularly simple manufacture of a thin-walled substrate tube without any tools.

Particularly preferred is a procedure in which in the elongation process according to measure (B) the magnitude ratio (AD_{V}/ID_{V})/(AD_{N}/ID_{N}) for the change of the diameter ratio of outer diameter to inner diameter of the tube to be elongated (AD_{V}/ID_{V}), based on the ratio of outer diameter to inner diameter of the elongated tube (AD_{N}/ID_{N}), is set to be in the range between 1.5 and 4.

If there is no change in the diameter ratio during elongation, this is called “ratio draw” and the above magnitude ratio is 1. However, no ratio draw is desired in the instant case, but a drawing operation with inflation wherein the inner diameter of the tube is increasing relative to the outer diameter, i.e. a magnitude ratio greater than 1 is obtained. It is the aim of the elongation process to achieve a draw rate that is as large as possible (based on the length) at the predetermined outer diameter of the elongated tube, with the proviso that the resulting wall thickness still ensures an adequate mechanical stability. With magnitude ratios below 1.5, this yields a slight change in comparison with the diameter ratio prior to the elongation process, so that the time and costs spent on performing the elongation process and the accompanying risks regarding waste of material (breakage, deformation) hardly pay off. Magnitude ratios above 4 entail considerable changes in the diameter ratio during elongation, which is accompanied with an increasing risk of uncontrolled deformation.

Furthermore, it has turned out to be useful when in the elongation process according to measure (B) a tube is produced having an outer diameter in the range between 30% and 70% of the outer diameter of the tube to be elongated.

At small outer diameters, a comparatively poor initial deposition efficiency is observed in the subsequent deposition process due to the small outer jacket surface. At large outer diameters, depending on the dimensions of the depositing device, a relatively small remaining layer height is obtained for the deposition until the maximally possible outer diameter is achieved for the starter tube and the mother tube, respectively.

In the method of the invention a tube is desired for use in the iterative procedure with a wall thickness that is as thin as possible for reasons of costs and is made as thick as possible for reasons of stability.

Therefore, it has turned out to be useful when the tube to be elongated is elongated in the elongation process according to measure (B) into a thin-walled tube having wall thicknesses ranging from 3 to 10 mm.

With wall thicknesses of less than 3 mm, problems tend to arise in the subsequent deposition process with respect to the mechanical and thermal stability of the tube. Deflections may occur, and the support-free length of the tube and its viscosity must here also be taken into account. With large wall thicknesses of more than 10 mm, the effect as regards the saving of costs is reduced due to the iterative procedure according to the invention.

Preferably, in the elongation process according to measure (B) a draw ratio is set to be in the range of from 3 to 10.

The greater the draw ratio is (the ratio of the lengths of the tube-after and before the elongation process), the smaller are the efforts based on the length of the resulting tube for producing and reworking the inner bore. With draw ratios below the said lower limit, a significant effect will no longer be observed in this respect. Draw ratios above the said upper limit tend to yield an outer diameter that is too small and detrimental to the efficiency of the depositing process.

Preferably, in the elongation process according to method step (c) or according to measure (B) the inner bore of the resulting tube is formed without any tools.

Hot deformation yields a smooth wall of the inner bore of the elongated tube.

It has turned out to be advantageous when the inner bore of the tube to be elongated is flushed with a flushing gas in the elongation process according to method step (c) or according to measure (B) or in the depositing process according to method step (b) or measure (A).

This prevents impurities from penetrating into the inner bore of the respective tube and counteracts the deterioration of the surface quality in the respective hot process.

With a view to this it has also turned out to be advantageous when the inner bore of the tube to be elongated in the elongation process according to method step (c) or according-to measure (B) or in the deposition process according to method step (b) or measure (A) is closed at one side.

This measure counteracts convection that may lead to the introduction of impurities into the inner bore or to undesired thermal effects.

On account of the repeated deposition and elongation processes the method according to the invention is well suited for the setting of defined radial refractive index profiles in the semifinished product. Preferred is however a variant of the method in which a semifinished product is obtained having a radially substantially homogeneous refractive index distribution. To this end in the deposition process according to method step (b) fluorine-doped quartz glass is produced having a fluorine content differing from that of the substrate tube by not more than +/−20% (based on the fluorine content of the substrate tube).

The invention will now be explained in more detail with reference to embodiments and a patent drawing. The drawing shows in detail in:

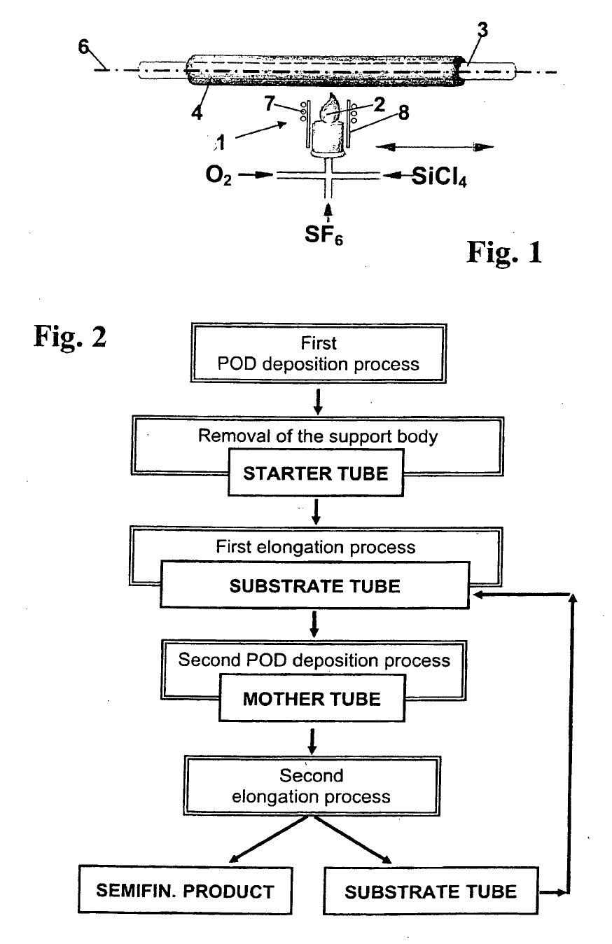

FIG. 1 a device for performing the POD method for the deposition of fluorine-doped quartz glass on a substrate tube; and

FIG. 2 a flow diagram with method steps and the respective method products in an embodiment of the method according to the invention.

FIG. 1 schematically shows a device for performing a method for the deposition of fluorine-doped quartz glass on a support tube 3. The support tube 3 consists. of undoped quartz glass and has an inner diameter of 30 mm and an outer diameter of 40 mm.

A layer 4 of fluorine-doped quartz glass is produced on the support tube 3 by means of a standard POD method. To this end SiCl₄, oxygen and SF₆ are supplied to a plasma burner 1 and are converted into SiO₂ particles in a burner flame 2 assigned to the plasma burner 1. Since the plasma burner 1 is reversingly moved along the support tube 3 from one end to the other one, the SiO₂ particles are deposited in layers on the outer cylindrical surface of the support tube 3 rotating about its longitudinal axis 6. It is thereby possible to incorporate high fluorine concentrations of more than 5% by wt. in the quartz glass network of the layer 4. The plasma flame 2 is produced inside a reaction sleeve 8 of quartz glass, which is surrounded by a high-frequency coil 7.

The rotational speed of the support tube 3 and the translational speed of the plasma burner 1 are set such that the individual quartz glass layers have a mean thickness of about 12 μm. A layer 4 of fluorine-doped quartz glass with a thickness of 15 mm is thereby produced.

Following the deposition process a heated etching gas stream of SF₆ is introduced into the bore of the support tube 3. The etching gas stream of SF₆ is configured such that the support tube 3 is completely removed and it is just the glass layer 4 that is obtained in tubular form with a wall thickness of about 15 mm. A mechanical treatment of the inner bore of the tubular form (=starter tube) is not needed.

As is schematically shown in FIG. 2, the starter tube produced in this way is subsequently drawn in an elongation process at a draw ratio of 3.4 without any tools into a thin-walled tube of fluorine-doped quartz glass having an inner diameter of 25 mm and an outer diameter of 40 mm and is inflated in this process. To this end an internal pressure which in comparison with the externally applied external pressure is raised by 5 mbar is maintained in the inner bore. This yields a tube which comprises an inner wall which is smoothed by hot deformation and has a particularly high surface quality.

The resulting tube is used either directly as a substrate tube for producing a semifinished product according to customer specification, or it is further processed as a starter material for producing substrate tubes for said intended use. In both cases additional fluorine-doped quartz glass is built up on the fluorine-doped quartz glass tube in a further POD deposition process and the mother tube obtained in this way is then elongated.
1. When used for producing a semifinished product according to customer specification the fluorine-doped quartz glass tube is directly used as the _{“}substrate tube”. To this end segments, each having a length of 70 cm, are produced from the substrate tube, and these segments are used in a second POD deposition process for the renewed deposition of a layer of fluorine-doped quartz glass, as has been described above for the making of the starter tube, resulting in a thick-walled “mother tube” of fluorine-doped quartz glass having an inner diameter of 25 mm and an outer diameter of 70 mm.

A tubular semifinished product having an inner diameter of 19 mm and an outer diameter of 25 mm is produced from the resulting mother tube in a second elongation process without any tools, and the quality of the surface of the inner bore does not significantly change in this elongation process. It is also during the second elongation process that an internal pressure raised in comparison with the externally applied external pressure is maintained in the inner bore, the internal pressure depending on the desired dimensions of the tubular semifinished product. The draw ratio is 16.2 in the embodiment.

Segments with the desired lengths are produced from the semifinished product obtained in this way, the segments being used as a component for making a preform.
2. When the fluorine-doped quartz glass tube obtained after the first elongation process is used for making a substrate tube for use in the manufacture of semifinished products according to customer specification, segments having each a length of 70 cm are also produced from the fluorine-doped quartz glass tube, and these are used in a second POD deposition process for the renewed deposition of a layer of fluorine-doped quartz glass, as has been described above, resulting in a thick-walled _{“}mother tube” of fluorine-doped quartz glass having an inner diameter of 25 mm and an outer diameter of 70 mm.

A substrate tube having an inner diameter of 25 mm and an outer diameter of 40 mm is produced from the resulting mother tube in a second elongation process without any tools. The draw ratio is here about 4.3 in the embodiment. The resulting substrate tube, or segments thereof, is again used in the manufacture of semifinished products for optical components, as has been explained above under 1, or for making further substrate tubes, as has been described under 2.

In the method according to the invention and particularly in the last-mentioned iterative variant of the method, based on the length of the resulting tubular semifinished product of fluorine-doped quartz glass and also with a high surface quality of the inner bore, the efforts required for the manufacture and treatment thereof are small.

1. A method for producing a tubular semifinished product of fluorine-doped quartz glass, the method comprising the following steps:
(a) providing a substrate tube consisting of fluorine-doped quartz glass;
(b) forming, in a deposition process, SiO2 particles by means of plasma burners in the presence of fluorine, and depositing said particles in layers on a cylindrical outer surface of the substrate tube rotating about longitudinal axis thereof so as to form a mother tube of fluorine-doped quartz glass; and
(c) elongating the mother tube in an elongation process so as to obtain the tubular semifinished product,
wherein method step (a) comprises an iterative method that comprises the following steps:
(A) in a starter tube deposition process, forming SiO2 particles are formed by means of plasma burners in the presence of fluorine, and depositing said particles so as to form a starter tube on a cylindrical outer surface of a support body rotating about a longitudinal axis thereof, and
(B) in a starter tube elongation process, elongating the starter tube into a tube of fluorine-doped quartz glass, wherein said tube is the support body in a subsequent iteration of step (A) or as the substrate tube provided by method step (a).

2. The method according to claim 1 wherein during a first run of the iterative method prior to the elongation process according to step (B) the support body is removed so as to form the starter tube of fluorine-doped quartz glass.

3. The method according to claim 2 wherein the support body used in the deposition process of step (A) is a hollow cylindrical support body having an inner bore and being of quartz glass, and wherein the support body is removed by introducing an etching gas into the inner bore thereof.

4. The method according to claim 1 wherein in the starter tube elongation process of step (B) the tube produced has an outer diameter corresponding to an outer diameter of the support body.

5. The method according to claim 1 wherein in the elongation process of method step (c) or of the starter tube elongation process of step (B) the tube to be elongated has an inner diameter that is changed by not more than +/−20% relative to (the inner diameter prior to the elongation process).

6. The method according to wherein in the elongation process according to method step (c) or the starter tube elongation process of step (B) an internal pressure that is higher than an external pressure applied to an outside of the substrate tube or the starter tube is produced and maintained in an inner bore of the substrate tube or the starter tube to be elongated.

7. The method according to claim 1 wherein in the elongation process of step (B) a magnitude ratio (ADV/IDV)/(ADN/IDN) of a change of a diameter ratio of an outer diameter to an inner diameter of the tube to be elongated (ADV/IDV), to a ratio of an outer diameter to an inner diameter of the elongated tube (ADN/IDN), is in the range between 1.5 and 4.

8. The method according to claim 1 wherein in the elongation process of step (B) a tube is produced having an outer diameter in a range between 30% and 70% of an outer diameter of the tube to be elongated.

9. The method according to claim 1 wherein the tube to be elongated is elongated in the elongation process of step (B) into a thin-walled tube having wall thicknesses ranging from 3 to 10 mm.

10. The method according to claim 1 wherein in the elongation process of step (B) a draw ratio is in the range of from 3 to 10.

11. The method according to claim 1 wherein in the elongation process of method step (c) or of step (B) the resulting tube has an inner bore that is formed without contact by any tools.

12. The method according to claim 1 wherein the tube to be elongated has an inner bore that is flushed with a flushing gas in the elongation process of method step (c) or of step (B) or in the deposition process of method step (b) or of step (A).

13. The method according to claim 1 wherein the tube to be elongated in the elongation process of method step (c) or of step (B) or in the deposition process of method step (b) or of step (A) has an inner bore that is closed at one side thereof.

14. The method according to claim 1 wherein in the deposition process of method step (b) fluorine-doped quartz glass is produced having a fluorine content differing from a fluorine content of the substrate tube by not more than +/−20% (relative to the fluorine content of the substrate tube).
